(19) United States
(12) Patent Application Publication
(10) Pub. No.: US 2014/0280406 A1
(43) Pub. Date: Sep. 18, 2014

(54) SYSTEMS AND METHODS FOR ESTIMATING UNCERTAINTY

(71) Applicant: GENERAL ELECTRIC COMPANY, Schenectady, NY (US)

(72) Inventors: Helena Goldfarb, Niskayuna, NY (US); Jeanette Marie Bruno, Saratoga Springs, NY (US); Richard Paul Messmer, Rexford, NY (US)

(21) Appl. No.: 13/841,832

(22) Filed: Mar. 15, 2013

(51) Int. Cl. G06F 17/10

(52) U.S. Cl. CPC G06F 17/10
USPC 708/201; 708/200; 708/670; 708/620

(57) ABSTRACT

A computer-implemented method includes receiving instructions to execute an analytic, wherein the instructions comprise one or more analytic inputs and a corresponding one or more uncertainty values, and wherein the analytic defines a continuous, monotonic mathematical function. The method includes executing the analytic using the one or more analytic inputs to determine one or more analytic outputs. The method also includes executing an uncertainty calculation to estimate one or more uncertainty outputs corresponding to the one or more analytic outputs, based, at least in part, on the one or more analytic inputs and the corresponding one or more uncertainty values. The method further includes providing the one or more analytic outputs as well as the corresponding one or more uncertainty outputs.

### BACKGROUND

The subject matter disclosed herein relates to estimating system level uncertainty based on modular uncertainties and, more specifically, relates to estimating how uncertainties associated with the inputs of a system of one or more analytics may be propagated through such a system to introduce uncertainty in the system output.

As processing power, memory size, and storage space have increased over the years, the complexity of models that may be effectively implemented using modern computing resources have generally increased as well. Such models may include, for example, engineering models, quantitative finance models, and molecular biology models, wherein complex, real-world problems may be abstracted into a useful model. In order to model such complex systems, the problem may be divided into a number of minimally interacting sub-problems that may be treated independently. Further, each sub-problem of the system may be solved with a particular analytic. As used herein, an analytic may be an algorithm, rule, model, or equation that may be suitably encapsulated in a software module. Accordingly, as a software module, each analytic in a system may receive one or more data inputs and produce one or more data outputs.

Further, each of the one or more data inputs of a particular analytic may have an associated uncertainty. For example, a measured value may have an associated uncertainty based upon the hardware limitations of the measuring device. By specific example, a temperature sensor may measure a temperature with a particular degree of accuracy, such as ±5%. As such, the temperature measurement provided by the temperature sensor may have an uncertainty of ±5%. Furthermore, when this temperature measurement is used as a data input of a particular analytic, the one or more outputs of the particular analytic will also have a particular uncertainty. For models of complex systems, which may include networks of interconnected analytics, the uncertainty introduced by a particular data input may be propagated throughout the network of analytics, and may introduce uncertainty into the one or more outputs of the model.

### BRIEF DESCRIPTION

In an embodiment, a computer-implemented method includes receiving instructions to execute an analytic, wherein the instructions comprise one or more analytic inputs and a corresponding one or more uncertainty values, and wherein the analytic defines a continuous, monotonic mathematical function. The method includes executing the analytic using the one or more analytic inputs to determine one or more analytic outputs. The method also includes executing an uncertainty calculation to estimate one or more uncertainty outputs corresponding to the one or more analytic outputs, based, at least in part, on the one or more analytic inputs and the corresponding one or more uncertainty values. The method further includes providing the one or more analytic outputs as well as the corresponding one or more uncertainty outputs.

In another embodiment, a system includes a memory storing a plurality of instructions that include a network of analytic nodes, wherein each analytic node of the network of analytic nodes defines a mathematical function. The system further includes a processing component configured to execute the plurality of instructions, wherein the plurality of instructions, when executed by the processing component, cause acts to be performed. The acts include receiving an input value and a corresponding uncertainty value and determining an output value as the value of the mathematical function at the input value. The acts also include determining or approximating a partial derivative of the function at the input value and performing an uncertainty calculation to estimate an uncertainty of the output value based on the determined or approximated partial derivative and the uncertainty value. The acts further include providing the output value and the estimated uncertainty of the output value.

In another embodiment, a non-transitory, computer-readable medium includes one or more instructions executable by a processor of an electronic device. The instructions include instructions to receive an input value and an uncertainty value and instructions to determine the output value of a mathematical function at the input value. The instructions include instructions to determine or approximate a partial derivative of the mathematical function at the input value and instructions to estimate an uncertainty of the output value based on the determined or approximated partial derivative and the uncertainty value. The instructions include instructions to provide the estimated uncertainty of the output value.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a hybrid block-flow diagram illustrating a system, in accordance with an embodiment of the present approach;

FIG. 2 is a hybrid block-flow diagram illustrating a model that includes an interconnected network of analytics, in accordance with an embodiment of the present approach;

FIG. 3 is a hybrid block-flow diagram illustrating an analytic module, in accordance with an embodiment of the present approach;

FIG. 4 is a hybrid block-flow diagram illustrating the analytic module of FIG. 3, along with an uncertainty estimation module and an analytic wrapper service, in accordance with an embodiment of the present approach;

FIG. 5 is a flow diagram illustrating a process by which the analytic wrapper service may determine an analytic output and its corresponding uncertainty, in accordance with an embodiment of the present approach;

FIG. 6 is a flow diagram illustrating the uncertainty estimation set forth in block 90 of FIG. 5, in accordance with an embodiment of the present approach; and

FIG. 7 is a graph illustrating an uncertainty estimation for an unknown function, in accordance with an embodiment of the present approach.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Additionally, as used herein, the term software module may refer to a set of instructions capable of being executed by a processor, including but not limited to, a function, a method, a program, or an application.

As set forth above, uncertainty introduced by one or more inputs to a particular analytic may be propagated to the one or more outputs of the particular analytic. Further, if the particular analytic is part of a network of analytics, then other analytics may utilize (as input) the output of the particular analytic, and the uncertainty associated with the output of the particular analytic may be further propagated through the network, introducing uncertainty into the final output or solution of the system. While the uncertainty of a complex system may be solved in limited circumstances (e.g., when the functions of the analytics are known) or may be estimated using statistical sampling techniques, the processing power, processing time, and/or prior knowledge of the functions needed for such approaches often renders their use impractical or inefficient.

As such, present embodiments are directed toward estimating uncertainty in the outputs of an analytic based on the uncertainty of the inputs of the analytic. Further, the present approach may be applied to networks of interconnected analytics (e.g., in a modular fashion) to determine how uncertainty is propagated through the network, allowing the estimate of corresponding uncertainty values for each of the final outputs or solutions of the network. The present approach is linear in time complexity, based on the number of analytic inputs, and does not require computationally intensive statistical sampling. Further, the present approach may enable estimation of the uncertainty associated with the execution of an analytic without knowing the internal workings (e.g., the mathematical function) of the analytic—allowing the analytic to be treated as a “black box” for the uncertainty calculation. Additionally, the present approach may be implemented using one or more wrapper or encapsulation mechanisms, allowing embodiments of the presently disclosed uncertainty calculator to be implemented around existing analytics, having any number of scalar or vector inputs and outputs, without alteration. Further, the present technique may be suitable for implementation in hardware (e.g., sensors, processors, controllers, etc.) or software, or may be provided as a service (e.g., hosted from a cloud).

With the foregoing in mind, FIG. 1 illustrates a system 10 for executing analytics, for example, to model a particular problem. The system 10 generally includes a computer 12 that is capable of executing instructions (e.g., software modules), receiving data input 14, and producing data output 16. As such, the illustrated computer 12 includes a processor 18 (e.g., a central computing unit (CPU), a graphics processing unit (GPU), and/or another suitable processor) and memory 20 (e.g., random access memory (RAM), read-only memory (ROM), and/or another suitable memory). Further, the processor 18 may be capable of executing instructions stored in the memory 20 to consume the data input 14 and produce the data output 16. The computer may further include a non-volatile storage 22 (e.g., a hard drive disk (HDD), solid-state disk (SSD), or another suitable nonvolatile storage) for storage of instructions or data (e.g., data input 14, data output 16, intermediate data, and so forth).

The computer 12 illustrated in FIG. 1 includes one or more input devices 24 (e.g., a mouse, keyboard, microphone, touch pad, touch screen, or another suitable input device) and output devices 26 (e.g., display, speaker, printer, or another suitable output device), as well as one or more network devices 28 (e.g., a network interface card), to allow the computer 12 to receive and provide data. For example, the computer 12 may receive data input 14 from one or more sources, such as from user 30, a sensor 32 (e.g., a temperature sensor, a pressure sensor, or another suitable sensor), and/or another processor 34 (e.g., another computer or suitable processor). Additionally, the computer 12 may provide data output 16 to one or more recipients, such as to the user 30, a controller 36 (e.g., an automation controller or control system), and/or another processor 34 (e.g., another computer or suitable processor).

The system 10 may enable the construction and execution of a model to solve a problem. That is, the system 10 may construct (e.g., in the memory 20 and/or the storage 22) a network of inner connected analytics, each representing a sub-problem, that consume the data input 14 to produce the data output 16. With the foregoing in mind, FIG. 2 is a hybrid block-flow diagram illustrating a model 40 that generally feeds a number of data inputs 14 into an interconnected network of analytics 42 in order to determine a number of data outputs 16.

It should be appreciated that the network of analytics 42 illustrated in FIG. 2 is merely an example, and other topologies (e.g., a single analytic node, a chain of analytic notes, and other suitable topologies) may also be used. For the illustrated network of analytics 42, certain analytical nodes (e.g., analytic nodes 44A, 44B, 44C, and 44E) may directly receive data inputs 14, while other analytic nodes (e.g., analytic nodes 44D and 44F) may generally receive, as data input, the outputs from underlying analytic nodes (e.g., analytic nodes 44A and 44B and analytic node 44D, respectively). As such, data input nodes 46A, 46B, and 46C may generally feed data input 14 into the analytic nodes 44 of the network of analytic nodes 42. Each analytic node 44 may apply their respective analytic to the data received either directly from a data input 14 or from another analytic node 44. Further, each analytic node 44 may provide their respective outputs either to another analytic node 44 (as inputs) or as a data output 16 of the model 40 (e.g., solution nodes 48A and 48B).

Furthermore, as illustrated in FIG. 2, present embodiments enable the estimation of uncertainty introduced by the data input 14, propagating through the network of analytic nodes 42, and affecting the data output 16 generated by the model 40. Accordingly, each of the data input nodes 46A, 46B, and 46C may, in addition to the input data, feed into the network of analytic nodes 42, an uncertainty value that corresponds to the corresponding data input. For example, data input node 46A may feed into analytic node 44A a value for input A as well as an uncertainty value that corresponds to the value provided for input A. As set forth above with respect to FIG. 1, the data inputs 14 provided to the network of analytics node 42 may come from, for example, a user 30, a sensor 32, and/or a processor 34. Accordingly, the user 30 may know and supply the both a particular data input as well as the uncertainty associated with the particular data input (e.g., from input node 46A) when the data input has a known uncertainty (e.g., based on uncertainty of a set of calculations, measurements, or generally accepted uncertainty values). Similarly, a sensor 32 or a processor 34 may store (e.g., in a memory) and supply both a particular data input as well as the uncertainty associated with the particular data input (e.g., from input nodes 46B and 46C, respectively) based on hardware limitations of the sensor 32 and/or processor 34, a known uncertainty of a set of calculations, measurements, or generally accepted uncertainty values. As set forth in greater detail below, in certain embodiments, each data input (e.g., data input nodes 46A, 46B, and 46C) may be capable of supplying more than one uncertainty input (e.g., an uncertainty value and an epsilon value) that are associated with a particular input (e.g., inputs A, B, and C, respectively).

Further, each of the analytic nodes 44 in the model 40 illustrated in FIG. 2 may be capable of receiving inputs and associated uncertainties from one or more input nodes (e.g., input nodes 46A, 46B, and 46C) and/or from one or more analytic nodes 44. For example, as illustrated in FIG. 2, the illustrated analytic 44B is configured to receive input B and the uncertainty associated with input B from the input node 46B as well as input C and the uncertainty associated with input C from the input node 46C. Accordingly, once the analytic node 44B has applied its analytic using inputs B and C and performed the associated uncertainty estimations (set forth in detail below), the analytic node 44B may output both a solution and one or more uncertainty outputs (e.g., an uncertainty value and an epsilon value, described below) associated with the solution to serve as input to analytic node 44D. Similarly, when the analytic nodes 44 near the edge of the network of analytic nodes 42 (e.g., analytic node 44F or 44E) output one or more solutions for the model 40 (e.g., solution nodes 48A or 48B), in addition to the solutions (e.g., solution A and solution B), the analytic node 44 may also output one or more uncertainty outputs associated with the solutions provided based on an uncertainty estimation, as set forth below.

FIG. 3 is a hybrid block-flow diagram that illustrates data flow within an embodiment of an analytic module 50. As such, the analytic module 50 may represent a portion of the processing that takes place at each analytic node 44 illustrated in FIG. 2, while the remaining processing performed at each node (e.g., the uncertainty estimation) is discussed in further detail below. As illustrated in FIG. 3, the analytic module 50 receives a number of analytic module inputs 52 (e.g., inputs 52A, 52B, and 52C) and provides a number of analytic module outputs 54 (e.g., outputs 54A, 54B, and 54C). As noted by the ellipses in FIG. 3, each analytic module 50 in the system 10 may include any suitable number of analytic module inputs 52 and analytic module outputs 54. Furthermore, as set forth above, each analytic module 50 includes an analytic implemented as one or more operations and/or calculations 56 within a software module. Accordingly, the analytic module 50 may apply the one or more operations and/or calculations to the analytic module inputs 52 to determine the analytic module outputs 54.

However, as set forth above, each analytic node 44 illustrated in FIG. 2 may include the execution of both an analytic module (e.g., the analytic module 50 illustrated in FIG. 3) and an uncertainty estimation module. With this in mind, FIG. 4 is a block diagram that illustrates an embodiment of an analytic wrapper service 60 that may control the execution of the analytic module 50. Further, the analytic wrapper service 60 may also control the execution of the uncertainty module 62 in order to estimate uncertainty in the execution of the analytic module 50 for a given set of analytic module inputs 52. That is, the analytic wrapper service 60 may execute the uncertainty module 62 to estimate an uncertainty value (e.g., uncertainty values 68) respectively associated with each of the analytic module outputs 54 based, at least in part, on the analytic module inputs 52.

Further, the analytic wrapper service 60 illustrated in FIG. 4 generally receives a number of analytic wrapper service inputs 64, which may be a combination of analytic module inputs 52 and uncertainty estimation module inputs 66. The analytic wrapper service inputs 64 may also include other inputs (e.g., the calculate uncertainty flag 67) that may be used to provide control parameters to the analytic wrapper service 60. The analytic wrapper service 60 may then convey the appropriate analytic wrapper service inputs 64 to the analytic module 50 and the uncertainty estimation module 62. Based on the outputs of these modules (e.g., analytic module outputs 54 and uncertainty estimation module outputs 68), the analytic wrapper service 60 may provide a number of analytic wrapper service outputs 70. Furthermore, in certain embodiments, during the course of controlling the execution of the analytic module 50 and the uncertainty estimation module 62, the analytic wrapper service may exchange data with a data cache 72, for example, to store intermediate calculated values and/or to pass inputs and outputs between analytic modules 50 and/or analytic nodes 44.

It should be appreciated that the analytic wrapper service 60 is merely provided as an example of a wrapper, and that other types and/or levels of wrapping or encapsulation may be possible. In other words, the analytic wrapper service 60 may be any set of processor executable instructions (e.g., a service, a software module, a function, a method, or another suitable set of instructions) capable of controlling the execution of the analytic module 50 and the uncertainty estimation module 62. It may further be appreciated that, in certain embodiments, the elements of FIG. 4 may be implemented in an object-oriented programming (OOP) fashion such that the analytic wrapper service 60 may be an instance of an analytic wrapper service class, the analytic module 50 may be an instance of an analytic module class, the uncertainty estimation module 62 may be an instance of an uncertainty estimation module class, and so forth. Further, in such a configuration, each analytic node 44 in the network of analytic nodes 42 (as illustrated in FIG. 2) may represent an instance of the analytic wrapper service class, or another suitable wrapper, instantiating and controlling one or more instances of the analytic module class and the uncertainty estimation module class. However, it should also be appreciated that a non-object-oriented approach (e.g., functional programming) may also be utilized without spoiling the effect of the present approach.

It may also be appreciated that, using the analytic wrapper service 60, as illustrated in FIG. 4, to control the execution of the analytic module 50 as well as the uncertainty estimation module 62 enables the uncertainty estimation to be performed on any suitable analytic module 50 without modification. That is, utilizing the analytic wrapper service 62, as illustrated in FIG. 4, allows the one or more operations and/or calculations 56 of the analytic module 50 to be focused on the analytic itself, and no additional instructions need to be included in the analytic module with respect to the uncertainty estimation. Similarly, utilizing the analytic wrapper service 60, as illustrated in FIG. 4, allows the uncertainty estimation module 62 to be a general solution that does not include instructions specific to a particular analytic module 50. As such, the same uncertainty estimation module 62, or separate instances thereof, may be applied to different analytic modules of the various analytic nodes 44, as illustrated in FIG. 2. However, while the use of the analytic wrapper service 60 may be advantageous for reasons set forth herein, in certain embodiments, the present uncertainty estimation technique may be implemented without the use of the analytic wrapper service 60 without spoiling the effect of the present approach.

As illustrated in FIG. 4, the uncertainty estimation module 62 may be a software module that includes a number of instructions to consume a number of uncertainty estimation module inputs 66 and to output a number of uncertainty estimation module outputs 68. In particular, the illustrated uncertainty estimation module 62 is configured to receive the analytic module inputs (e.g., X₁ through Xₙ), and is also configured to receive two uncertainty inputs (e.g., X₁ uncertainty 74 and X₁ epsilon 76) for each of the analytic module inputs 52. In terms of the uncertainty estimation module outputs 68, the uncertainty estimation module 62 may generate, for each of the analytic module outputs 54 (e.g., Y₁ through Yₘ), a corresponding uncertainty value (e.g., Y₁ uncertainty through Yₘ uncertainty). Example of processes by which the uncertainty estimation module 62 may determine the uncertainty estimates (e.g., uncertainty estimation module outputs 68) are set forth in detail below.

FIG. 5 is a flow diagram that illustrates a process 80 by which an analytical node 44 (e.g., an instance of the analytical wrapper service 60 as illustrated in FIG. 4) may be executed by the processor 18 of the system 10 to determine, for a particular analytic module 50, a number of outputs (as well as their respective uncertainties) based on a number of inputs (as well as their respective uncertainties). The illustrated process 80 begins with receiving (block 82) instructions and analytic module inputs 52 to execute an analytic module 50, as well as receiving uncertainty estimation module inputs 66 for estimating uncertainty when executing the analytic module. Next, the processor 18 may determine if (block 84) the calculate uncertainty flag 67 (e.g., a Boolean value) in the analytic wrapper service inputs 64 has been set. If the processor 18 determines that the calculate uncertainty flag 67 has not been set (e.g., has a value of 0 or false), then the processor 18 may execute (block 86) the analytic module 50 normally using the received values of the analytic module inputs 52, and may provide one or more analytic module outputs 54.

If, however, the processor 18 determines that the calculate uncertainty flag 67 has been set (e.g., has a value of 1 or true), then the processor 18 may execute (block 88) the analytic module 50 a first time using the received values for the analytic module inputs 52 in order to generate the one or more analytic module output values. Next, as set forth in detail below, the processor 18 may estimate (block 90) uncertainty values (e.g., uncertainty estimation module outputs 68) based, at least in part, on the received analytic module inputs 52 and the received uncertainty inputs 66. Finally, the processor 18 may provide (block 92) the determined one or more analytic module outputs as well as the corresponding uncertainty values, for example, to an output device 26, a network device 28, or the storage 22 illustrated in FIG. 1, or to another analytic node 44 in the network of analytic nodes 42 illustrated in FIG. 2.

FIG. 6 expands on block 90 of FIG. 5, illustrating an embodiment of a process 90 by which an uncertainty estimation module 62 may be executed by the processor 18 of the system 10 to estimate an uncertainty value for each of the analytical module outputs 54 based upon the uncertainties of each of the analytical module inputs 52. The process 90 illustrated in FIG. 6 begins with the processor determining if (block 100) all of the analytic module inputs have been processed. If not, the processor 18 may then select (block 102) a particular analytic module input and determine, from the received uncertainty estimation module inputs 66 and uncertainty value 74 and an epsilon value 76 that corresponds to the selected analytic module input.

In certain embodiments, the epsilon value 76 may be provided by the user 30 (e.g., an expert), may be based on the nature of the function defined by the analytic (e.g., based on the linearity of the function). As discussed in greater detail below, the epsilon value 76 determines how the uncertainty estimation module should vary a particular analytic module inputs before executing the analytic module 50 once more using the varied analytic module inputs 52. In certain embodiments, the epsilon value 76 may not be provided (e.g., to the analytic wrapper service 60 and/or the uncertainty estimation module 62) and, instead, a default value (e.g., 0.5, 0.1, 0.01, or another suitable default value) may be used. Further, in certain embodiments, the epsilon value 76 may be fixed throughout the computation, or, in certain embodiments, may vary across the dimensions of the input data (e.g., based on the linearity of the function in a particular domain).

Continuing through the process 90, next the processor 18 may modify (block 104) the value of the selected analytic module input based on the corresponding epsilon value 76. For example, in certain embodiments, the processor 18 may modify the value of the selected analytic module input by adding the epsilon value 76 to the value of the selected analytic module input. Then, the processor 18 may execute (block 106) the analytic module once more using the modified value of the analytic module input to determine one or more analytic module outputs 54, which may be designated as modified analytic module outputs for clarity. It should be appreciated that, in certain embodiments, while the value of the selected analytic module input may be modified before executing the analytic module once more, the remainder of the analytic module inputs 52 may remain unchanged to allow the uncertainty estimation module to estimate the uncertainty contribution of the selected analytic module input.

The process 90 illustrated in FIG. 6 continues with the processor 18 estimating (block 108) the uncertainty contribution of the selected analytic module input to each of the one or more analytic module outputs based, at least in part, on the determined one or more analytic module outputs (as determined in block 88) and the determined one or more modified analytic module outputs (as determined in block 106). An example embodiment of this estimation is presented below with respect to FIG. 7.

Finally, the process 90 terminates when all analytic module inputs have been processed according to blocks 102, 103, 106, and 108, allowing the processor 18 to combine (block 110) or sum the uncertainty contributions estimated for each of the analytic module inputs to each of the one or more analytic module outputs (e.g., in block 108) to generate an uncertainty value for each of the one or more analytic module outputs 54. For example, assuming two analytic module inputs 52, namely X₁ and X₂, and two analytic module outputs 54, namely Y₁ and Y₂, if the processor 18 estimates that the uncertainty contribution of X₁ is 0.05 to Y₁ and −0.3 to Y₂, and further estimates that the uncertainty contribution of X₂ is −0.4 to Y₁ and 1.2 to Y₂, then in block 110, the processor 18 may estimate that the total uncertainty contribution of all analytic module inputs (X₁ and X₂) in 52 to all analytic module outputs (Y₁ and Y₂) in 54 is ±0.35 to Y₁ and ±0.9 to Y₂.

Turning to FIG. 7, an example embodiment of the uncertainty contribution estimation is illustrated (e.g., as set forth in block 108 of FIG. 6). The graph 120 illustrated in FIG. 7 includes, on the independent axis 122, the analytic module input xᵢ (e.g., as selected in block 102 of FIG. 6), and on the dependant axis 124, the output of the analytic module 50, M(xᵢ). As such, the curve 126 represents the function M(xᵢ), the output of the analytic module 50 as a function of the analytic module input xᵢ. It should be appreciated that, in certain embodiments, the function M may be a continuous, smooth, and monotonic function. It should further be appreciated that the example illustrated in FIG. 7 represents a single variable case for simplicity; however, it should be appreciated that, the present approach may be applied to multiple variable situations as well.

With respect to FIG. 7, it may be noted that the input uncertainty function, u, gives the uncertainty u(xᵢ⁰) at the value xᵢ⁰, which may be provided as an input to the uncertainty estimation module (e.g., uncertainty input 74). Further, actual uncertainty, U(y⁰), may be defined as the maximum of M(xᵢ)−M(xᵢ⁰) on the interval [xᵢ⁰−u(xᵢ⁰), xᵢ⁰+u(xᵢ⁰)]. As such, one estimate for uncertainty may be the absolute value of the product of the partial derivative of M at xᵢ⁰ (e.g., M′(xᵢ⁰) or it can be also written as a

$$\frac{\partial M}{\partial {x}_{i}} ( {x}_{i}^{0} ) )$$

with the maximal deviation (e.g., u(xᵢ⁰)) in the given interval. Accordingly, in certain embodiments, the uncertainty estimation module may estimate uncertainty contributions for each analytic module input according to the Eq. 1 (for known functions) or estimate the partial derivatives with respect to each input for unknown functions, as set forth below.

$$Estimated Uncertainty Contribution = \vert \frac{\partial M}{\partial {x}_{i}} ( {x}_{i}^{0} ) \times u ( {x}_{i}^{0} ) \vert \qquad Eq . 1$$

With the foregoing in mind, the graph 120 of FIG. 7 illustrates an example embodiment of the uncertainty contribution estimation for an unknown function, M. That is, as set forth above, in certain embodiments, the present approach may be utilized for a known function; however, estimating uncertainty for unknown functions or “black box” is discussed below. Further, the point 128 illustrated in FIG. 7 represents the value of the function M at xᵢ⁰, in which xᵢ⁰ is the value of the analytic module input as received (e.g., from a user, sensor, processor, another analytic node, and so forth) by the uncertainty estimation module. For example, the point 128 may correspond to the analytic module output determined for the received analytic module input (e.g., in block 88) during the first execution of the analytic module 50. As illustrated in FIG. 4, in certain embodiments, the analytic wrapper service 60 may make this initial analytic module output available to the uncertainty estimation module via the data cache 72, as an uncertainty estimation module input 66 (not shown), or by other suitable means.

As illustrated in FIG. 7, in certain embodiments, the uncertainty estimation module 62 may determine an approximation of the partial derivative for the function with respect to each analytic module input

$$( e . g . , \frac{\partial M}{\partial {x}_{i}} ( {x}_{i}^{0} ) ) .$$

For example, the epsilon value 76, ε, may be used to determine an approximation of the partial derivative based on equations Eq. 3 and Eq. 4 below. It may be appreciated that, since the epsilon value 76, ε, may be a small, positive number, then the difference between

$$\frac{\partial M}{\partial {x}_{i}} ( {x}_{i}^{0} )$$

and ΩᵢM(xᵢ⁰, ε) may be negligible, therefore the partial derivative may be estimated by Eq. 3.

$$\begin{matrix}{Ω}_{i} M ( {x}_{i}^{0} , ɛ ) = \frac{M ( {x}_{i}^{0} + ɛ ) - M ( {x}_{i}^{0} )}{ɛ} & Eq . 3 \\ \frac{\partial M}{\partial {x}_{i}} ( {x}_{i}^{0} ) = {lim}_{ɛ -> ∞} {Ω}_{i} M ( {x}_{i}^{0} , ɛ ) = {lim}_{ɛ -> 0} \frac{M ( {x}_{i}^{0} + ɛ ) - M ( {x}_{i}^{0} )}{ɛ} & Eq . 4\end{matrix}$$

Subsequently, the analytic module 50 may be executed once more using an analytic module input has been modified using the epsilon value 76 (e.g., to determine M(xᵢ⁰+ε)), as set forth in block 106 of FIG. 6 and Eq. 3. For example, graph 120 of FIG. 7 illustrates the distance 130 defined by the epsilon value 76, ε, with respect to the initial analytic module input value, xᵢ⁰. At this distance 130, a point 132 is illustrated, representing the value of the function M at (xᵢ⁰+ε). Further, the line 134 connects the points 128 and 132, representing the approximated partial derivative of the function M, as determined based on Eq. 3. FIG. 7 also illustrates a second distance from xᵢ⁰, distance 136, which may be defined by u(xᵢ⁰), the received uncertainty value for xᵢ⁰. The graph 120 also includes a horizontal line 138 extending from the point 128 along the distance 136. As such, the illustrated distance 140 illustrates the result of Eq. 1 (e.g., the absolute value of the product of the partial derivative and u(xᵢ⁰)), which is the estimated uncertainty contribution for M(xᵢ) at xᵢ⁰. This may be compared to the distance 142, which illustrates the actual uncertainty of M(xᵢ) at xᵢ⁰.

In other embodiments, if the function M is known, this information may be utilized to determine the partial derivative of the function M rather than rely on the approximation of the partial derivative discussed above. That is, the uncertainty estimation module 62 may directly determine the derivative (e.g., M′(xᵢ⁰)) for the function M, with respect to each analytic module input. Accordingly, once the partial derivative M′(xᵢ⁰) has been determined, then Eq. 1 may be utilized to determine the estimated uncertainty contribution for xᵢ⁰. It may be appreciated, therefore, that when the function M is known, then the epsilon value 76 may not be used, and the analytic module need not be executed a second time (e.g., with a modified analytic module input) since the partial derivative may be directly determined. While this may hold advantages in terms of performance, in many real world cases, the function may not be known. Accordingly, the present approach is robust, capable of estimating uncertainty in known or unknown functions, or even combinations thereof.

Technical effects of the present approach include a computationally efficient technique for estimating uncertainty of either known or unknown analytics.

The present approach allows the estimation of the uncertainty of individual analytics, or analytics arranged as a network of interconnected nodes, to estimate how the uncertainties of analytic inputs are propagated through the network. The present approach is linear in time complexity—on the order of n, O(n), where n is the number of analytic module inputs. By comparison, this is significantly more efficient than statistical sampling methods, which are typically on the order of O(m to the power of n) where m represents the number of samples (e.g., usually greater than 10). Further, the disclosed implementations include embodiments in which the analytic may be wrapped or encapsulated by a service to control the execution of the analytic and the uncertainty estimation. This may enable a common uncertainty estimation module that may be used to estimate uncertainty of any number of different analytics without alteration of the uncertainty estimation module or the analytics.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method, comprising:
receiving instructions to execute an analytic, wherein the instructions comprise one or more analytic inputs and a corresponding one or more uncertainty values, and wherein the analytic defines a continuous, monotonic mathematical function;
executing the analytic using the one or more analytic inputs to determine one or more analytic outputs;
executing an uncertainty calculation to estimate one or more uncertainty outputs corresponding to the one or more analytic outputs, based, at least in part, on the one or more analytic inputs and the corresponding one or more uncertainty values; and
providing the one or more analytic outputs as well as the corresponding one or more uncertainty outputs.

2. The method of claim 1, wherein the uncertainty calculation scales linearly in computation time with a number of the one or more analytic inputs.

3. The method of claim 1, wherein executing the uncertainty calculation, comprises:
for each particular analytic input of the one or more analytic inputs:
determining a partial derivative of the function at a value of the particular analytic input;
determining an uncertainty value from the one or more uncertainty values corresponding to the particular analytic input; and
estimating an uncertainty contribution of the particular analytic input based, at least in part, on the corresponding uncertainty value and the determined partial derivative.

4. The method of claim 3, wherein estimating the uncertainty contribution of the particular analytic input comprises determining the product of the corresponding uncertainty value and the determined partial derivative.

5. The method of claim 1, wherein executing the uncertainty calculation, comprises:
for each particular analytic input of the one or more analytic inputs:
determining a modified value for the particular analytic input based, at least in part, on a value of the particular module input;
re-executing the module using the modified value for the particular module input to determine one or more modified module outputs; and
estimating an uncertainty contribution of the particular module input based on the one or more module outputs and the one or more modified module outputs.

6. The method of claim 5, wherein determining the modified value for the particular analytic input comprises adding, to the value of the particular analytic input, a corresponding epsilon value.

7. The method of claim 5, wherein estimating the uncertainty contribution of the particular analytic input comprises determining the product of the corresponding uncertainty value and the determined partial derivative.

8. The method of claim 5, wherein estimating the uncertainty contribution of the particular analytic input, comprises:
approximating a partial derivative of the function with respect to the particular analytic input at a value of the particular analytic input; and
estimating the uncertainty contribution of the particular analytic input based, at least in part, on the corresponding uncertainty value and the approximated partial derivative.

9. The method of claim 1, wherein executing the uncertainty calculation further comprises summing an estimated uncertainty contribution of each of the one or more module inputs to determine the one or more uncertainty outputs.

10. The method of claim 1, wherein the one or more analytic inputs are received from one or more outputs of another analytic.

11. The method of claim 1, wherein the one or more analytic inputs and the corresponding one or more uncertainty values are received from a sensor, a processor, or a user.

12. The method of claim 1, wherein the one or more analytic outputs and the corresponding one or more uncertainty outputs are provided as one or more analytic inputs and one or more uncertainty inputs to another analytic.

13. A system, comprising:
a memory storing a plurality of instructions comprising a network of analytic nodes, wherein each analytic node of the network of analytic nodes defines a mathematical function; and
a processing component configured to execute the plurality of instructions, wherein the plurality of instructions, when executed by the processing component, cause acts to be performed, comprising:
receiving an input value and a corresponding uncertainty value;
determining an output value as the value of the mathematical function at the input value;
determining or approximating a partial derivative of the function at the input value;
performing an uncertainty calculation to estimate an uncertainty of the output value based on the determined or approximated partial derivative and the uncertainty value; and
providing the output value and the estimated uncertainty of the output value.

14. The system of claim 13, wherein the input value and the corresponding uncertainty value is received from another analytic node in the network of analytic nodes.

15. The system of claim 13, wherein the output value and the estimated uncertainty of the output value are provided, as input, to another analytic node in the network of analytic nodes.

16. The system of claim 13, wherein the output value is provided as a solution to a model comprising the network of analytic nodes, and wherein the estimated uncertainty of the output value represents an estimated uncertainty of the solution across the network of analytic nodes.

17. The system of claim 13, wherein the pluarality of instructions, when executed by the processing component, cause further acts to be performed comprising:
determining a modified input value using a received epsilon value;
determining a modified output value as the value of the mathematical function at the modified input value; and
approximating the partial derivative of the mathematical function as the modified output value minus the output value divided by epsilon.

18. The system of claim 17, wherein epsilon is a small, positive number between approximately 0.5 and approximately 0.01.

19. A non-transitory, computer-readable medium, comprising one or more instructions executable by a processor of an electronic device, the instructions comprising:
instructions to receive an input value and an uncertainty value;
instructions to determine the output value of a mathematical function at the input value;
instructions to determine or approximate a partial derivative of the mathematical function at the input value;
instructions to estimate an uncertainty of the output value based on the determined or approximated partial derivative and the uncertainty value; and
instructions to provide the estimated uncertainty of the output value.

20. The computer-readable medium of claim 19, wherein the instructions to estimate an uncertainty of the output value comprises instructions to estimate an uncertainty of the output value as the absolute value of the product of the determined or approximated partial derivative and the uncertainty value.
